(19) United States
(12) Patent Application Publication
(10) Pub. No.: US 2011/0259219 A1
(43) Pub. Date: Oct. 27, 2011

(54) A Method of Printing

(75) Inventor: Bruce Behrens, Glenbrook New South Wales (AU)

(73) Assignees: KIRK ENGINEERING SERVICES (AUSTRALIA) PTY LIMITED, Minto, New South Wales (AU); AMCOR LIMITED, Hawthorn, Victoria (AU)

(21) Appl. No.: 13/119,845

(22) PCT Filed: Sep. 21, 2009
(86) PCT No.: PCT/AU09/01250

§ 371 Date: Jun. 10, 2011

(30) Foreign Application Priority Data
Sep. 19, 2008 (AU) 2008904894

(51) Int. Cl. B41F 9/02; B41M 1/10

(52) U.S. Cl. 101/152; 101/170; 101/401.1

(57) ABSTRACT

The present invention relates to a method of printing on a polymeric film using a gravure printing press, a method of making rollers for a gravure printing press and a set of gravure rollers. The invention enables standardised process colours such as, CYMK colours to be combined to from non-standardised process colours such as, secondary and tertiary colours via a select range of screen angles and screen rulings.

### FIELD OF INVENTION

The present invention relates to a method of printing using a gravure printing press, a method of manufacturing a set of rollers for a gravure printing press and a set of rollers for a gravure printing press.

### BACKGROUND OF THE INVENTION

There is a very large volume of packaging produced in the world today that is formed partially or wholly from polymeric films. Printing on polymeric films is typically achieved using either gravure or flexographic printing processes, although other printing process such as lithographic (also known as offset) and inkjet process are also known in the art.

### Preparation of Images for Polymer Printing

The graphics applied to polymeric films are typically initially prepared by a graphics designer acting on the instructions of the brand owner. A ‘brand owner’ in this context is a term used to describe a company that manufactures, either directly or indirectly, and sells or distributes branded products for which it either owns or licences the relevant brand rights. For example, Coca Cola is a brand owner in relation to Coca Cola and many other products.

The graphics designer will need to take into account the information that the brand owner wishes to put on the packaging, and the functional limitations of the packaging, including the area available and the printing limitations of the packaging material and the printing process.

The graphics as prepared by the graphic designer will typically comprise a combination of ‘solid tone’ and ‘continuous tone’ areas. The solid tone areas are uniform in colours and may be used for the background of the image, or the logo of the brand, or any other part of the graphic where a uniform colour is required. The continuous tone areas are used where a non-uniform colour is required, for example where a picture of the product being packaged is shown. Consumer packaging typically is dominated by solid tone areas, although this does not apply in all situations.

Sometimes the colours used for the solid tone areas are brand colours, i.e. colours used by brand owners to help communicate the source of the product. In this situation the brand owner requires a consistent reproduction of the brand colours.

Regardless of whether solid or continuous tone graphics are being printed, the gravure, flexographic and lithographic (and other printing processes such as inkjet) printing processes all require separation of the graphics into a series of colour ‘layers’, where each colour layer represents the printing on the polymeric film by a single ink colour. Successive applications of different ink colours over the same area can lead to the final fully-coloured graphic seen by the consumer.

Specific colours are typically reproduced on packaging films in one of two methods. In a first method of producing a specific colour, the final colour is formed by combining half tone dots printed by a combination of so called ‘process colours’.

The most common standard process colours are the so-called ‘negative primary’ colours. These negative primary colours are cyan (a specific shade of light blue), yellow, magenta (a specific shade of pink) and black. In combination these colours are referred to in the art as ‘CYMK’ colours, with the K referring to ‘key’, a printing term for black.

A second set of standard process colours are the so-called ‘positive primary colours’, these being the red, green and blue (referred to as RGB), which are more commonly used for producing television and other electronic media images.

While the colours achieved by a combination of process colours are often adequate for most photographs, text, and other general images, it can be difficult to use these four colours to perfectly recreate specific colours, in particular the specific colours selected by brand owners to distinguish their products and brands.

The second method for reproducing specific colours is to use the exact ink colour that we want to reproduce, often in combination with a set of standard process colours. These can be used to apply both solid and continuous tone images. For this reasons printing presses of up to ten different colours (or ‘colour units’) are sometimes used for printing polymer films, although six or seven rollers are more commonly used.

### Gravure Printing

The gravure (also known as rotogravure) printing technology is based on the use of engraved copper rollers to collect and then transfer ink to the polymer film. Small cells of about 10 to 200 μm in width, and approximately in the shape of a diamond, are engraved into the gravure roller, and these cells collect ink from an inking fountain and then transfer this ink to the substrate in a printing nip as an array of small ‘half tone dots’. The position and the depth of these cells controls the density of the colour as seen by the naked eye, which in most cases cannot see the gaps between the half tone dots and instead ‘sees’ a continuous colour.

After each colour unit the printed film passes through a dryer to dry the ink before the next colour layer is printed on the film.

### Prepress Activities

A series of steps is required to convert a graphic image as received from the designer to an image that can be converted into a gravure roller. These steps are collectively known as the ‘prepress’ process, and typically comprise:
a) Separation of the graphic images to the individual colour channels or layer. Typically this is done using software such as Adobe Photoshop or Artpro running on Apple Macintosh computers, although other software and hardware is known in the art. These separation processes can be adjusted as required to achieve a given end effect.
b) Production of a proof for approval by the designer or brand owner. This proof is typically created by using either an inkjet printer or a Kodak Danor printer, and involves the recombination of the colour channels created in step a) to produce an image broadly representative of final printed image.
c) Approval of the proof by the designer or brand owner
d) Adjustment of the individual colour channel images to allow for the practical limitations of any printing process, for example:
   compensating for the amount of ink actually transferred from the printing roller or plate onto the polymer film,
   compensating for the increase in the size of the half tone dots on the printed substrate compared to the size of the cells in the gravure cylinder (known in the trade as ‘dot gain’,
   ensuring that the half tone dots are positioned to minimise to over printing half tone dots from successive colours from being printed on top of each other, and
   allowing for difficulties in reproducing either very light or very dark parts of individual colour channels.
   One of the tools typically used for these adjustments is the use of ‘gamma curves’, which adjust the amount of ink applied in a given area of a colour channel for the known or measured imperfections in the printing process.
e) Duplication of the graphic. A printing roller or plate may typically include multiple copies of the graphic to be produced, as the cut size of the packaging is often much smaller than the area of the printing plate or roller. This step is often combined with the image correction discussed in point d) and done using suitable computer software and hardware.
f) The print roller or printing plates are then produced from the collaged images using methods known in the art.

### Setting Up the Press

There is also considerable setting up once the printing rollers or plates are on the printing press. There are a number of parameters that need to be adjusted for each print unit to ensure that the proof that the designer or brand owner signed off on can be accurately reproduced. In particular amount of ink applied with each print unit may need to be adjusted or balanced to ensure accurate reproduction. Sometimes the shade of colours of the ink are adjusted to help reproduction of the proof.

### Limitations of Known Processes for the Printing of Polymer Film

There are two major limitations with the gravure, flexographic or lithographic printing process as they are typically applied for the printing of polymer based packaging film:

1) The high cost of using multiple colour rollers.

One of the major costs of polymer based printing is the cost of preparing the printing rollers or plates. Every new graphic to be printed requires new rollers to be created, and a new printing roller or printing plate to be created for each colour used. As an example, the cost of engraving a single gravure roller can range from $1,000 to $2,000 per roller or more.

For this reason, it is desirable to reduce the number of gravure rollers used. However, a typical print run will require both standard process colours, such as the CYMK process colours, and one or more non-standardised process colour inks that are specifically required by the brand or their graphic designers. Non-standardised process colours, often known as ‘spot colours’ are selected by brand owners and sometimes as part of their corporate branding strategy. They are typically applied in uniform areas, which can be a background or surround to another image, a solid border, solid lettering, background to solid lettering and other uniform colour areas on a printed image. However a common feature of non-standardised process colours is that they are typically applied using a separate and dedicated gravure printing roller as a uniform ink colour that differs from the standardised CYMK or RGB ink colours.

The main reason for using non-standardised process colour inks is that heating of the printed film used to solidify the ink between the subsequent colour units can lead to a slight dimensional distortion of the film. Although this distortion is unseen by the human eye, this can mean that the position of the half tone dots can be displaced slightly. When image colours are being produced by combining half tone dots of the standard colours, it is necessary that the dots from the separate colour units are not printed on top of each other, but instead each half tone dot is printed in a slightly different part of the film. If subsequent half tone dots are printed on top of each other, there will be a slight change in the perceived colour of the image at this location. While the naked eye will be unlikely to see the detail of this over-printing at any one position, this can lead to a interference or ‘moiré’ pattern developing over a wider area of the final printed image. This is also know as ‘misregister’. This can lead to significant image distortion or waviness that the human eye can recognise, even if the untrained human eye does not what is causing the waviness. In turn this leads to an inability to create the uniform and specific colours desired in the commercial printing of polymer films, especially if the images being printed include large areas of uniform or block colours commonly seen in polymeric packaging.

For this reason the commercial gravure printing of polymer films is commonly carried out using between 7 and 10 gravure rollers, with some of these rollers containing the non-standardised or ‘spot’ colours. The use of the spot colour units of the desired colour is the commonly used method in the art to ensure the uniform and specific reproduction of solid tone colours. However even the use of 7 to 10 gravure rollers can still lead to moire effects in the final images.

2) The time required to set up the printing press.

The use of a multiple colour channels can lead to very long set up times, as the printers work to balance the different print units. A higher number of print units will naturally lead to a more complicated set up time.

This is further complicated as the use of different non-standardised or spot colours for different jobs means that setup may need to be drastically altered for each job.

In practice it can take two to three hours to set up a printing press for a print job with six or seven colours, adding considerably to the cost of the print job.

It is an object of the present invention to provide alternative printing process.

### SUMMARY OF THE INVENTION

The present invention is based on the realisation that all non-standardised process colours of an image can be formed by combining standardised process colours.

The present invention relates to a method of printing an image on a polymeric film using a gravure printing press having a plurality of gravure rollers, the method including:

sequentially applying at least 2 standardised process colours to the polymeric film in half tone dots by respective gravure rollers, wherein at least a portion of the half tone dots of two or more standard process colours combine to form non-standardised process colour(s), and a range of screen angles and a range of screen rulings are selected for the half tone dots of each standardised process colour to minimise mis-registration of the half tone dots that combine to form the non-standardised process colour, and wherein all of the non-standardised process colours of the image are formed by combining 2 or more of the standardised process colours.

It is within the scope of the present invention that more than 2 standardised process colours are applied to the polymeric film, for instance, 2 to 6 standardised process colours may be applied. In an embodiment, the method includes applying at least 3 standardised process colours, each standardised process colour is applied to the polymeric film in half tone dots and the half tone dots of each standardised process colour is applied over a range of screen angles and over a range of screen rulings that are selected to minimise mis-registration of the half tone dots that combine to form the non-standardised process colours, and wherein all of the non-standardised process colours of the image are formed by combining any 2 or more of the standardised process colours.

The standardised process colours may comprise 4 or more colours such as cyan, magenta, yellow, and black. The standardised process colours may also include red, green, and blue.

The non-standardised process colours may be the product of a combination of the any 2 or more of the standard process colours and includes secondary and tertiary colours. Non-standardised process colours may include ‘spot colours’ or colours selected by brand owners that sometimes form part of their corporate branding strategy. Non-standardised process colours may be applied in uniform areas, which can be a background or surrounding to another image, a solid border, solid lettering, background to solid lettering and other uniform colour areas on a printed image. Non-standardised process colours do not include speciality colours such as metallic coloured ink, florescent coloured ink, or varnishes.

Throughout this specification, the term polymeric film embraces a substrate comprising a single polymeric layer or a composite substrate having at least one polymeric layer and at least one layer of non-polymeric material such as paper or metallic materials.

Throughout this specification the term ‘screen rulings’, refers to the number of lines of half tone dots on the polymeric film or the number of lines of cells on the gravure roller per unit width of the printing roller, for example in units lines/cm.

Throughout this specification the term ‘screen angles’ refers to the angle of the sides of the diamond shape of the half tone dots or the cells with respect the axis of the printing roller.

Throughout this specification the term ‘Screen percentage’ refers to the percentage of any area of a colour layer that is printed by the ink. Screen rulings can range from 0% (no ink is applied) to 100% (the area is fully printed).

### DETAILED DESCRIPTION

In an embodiment, all of the non-standardised process colours appearing in the image are created by combining at least two, and optionally any 3 or any 4 of the standardised process colours.

In an embodiment, the non-standardised process colours may be part of either a solid tone area or a continuous tone area of the image.

In the situation in which the standardised process colours include any one of cyan, yellow, magenta and blank, the screen angles of the half tone dots thereof may include any one of:
from 55 to 65 degrees for cyan,
from 42 to 52 degrees for yellow,
from 32 to 42 degrees to magenta, and
from 35 to 45 degrees for black.

In a particular embodiment, the screen angles are approximately 59 degrees for cyan, 47 degrees for yellow, 37 degrees for magenta, and 40 degrees for black.

In the situation in which the standardised process colours include any one of cyan, yellow, magenta and black, the screen rulings of the half tone dots thereof may include any one of:
from 65 to 75 lines per cm for cyan,
from 52 to 62 lines per cm for yellow,
from 65 to 70 lines per cm for magenta, and
from 90 to 110 lines per cm for black.

In a particular embodiment, the screen rulings are approximately 70 lines per cm for cyan, 57 lines per cm for yellow, 70 lines per cm degrees for magenta, and 99 lines per cm for black.

In the situation in which the standardised process colours include any one of cyan, yellow, magenta and black, and the screen rulings are applied at 100% to the polymeric film, the standardised process colours may cover the following ink to film weights:
less that 1.4 g/m² for yellow,
less than 1.0 g/m² for magenta,
approximately 0.8 g/m² for cyan, and
more than 0.5 g/m² for black.

Even more suitably, the standardised process colours may be applied in approximately the following film weights:
0.8 g/m² for yellow,
0.9 g/m² for magenta,
0.8 g/m² for cyan, and
0.9 g/m² for black.

In the situation in which the standardised process colours include any one of cyan, yellow, magenta and black, and the screen rulings are applied at 100% to the polymeric film, the half tone dots may cover the following widths:
less than 184 μm for cyan,
greater than 156 μm for yellow,
greater than 123 μm for magenta, and
less than 186 μm for black.

Even more suitably, the widths of the half tone dots at 100% screen rulings may be approximately:
143 μm for cyan,
181 μm for yellow,
176 μm for magenta, and
118 μm for black.

In an embodiment, the channel widths between the half tone dots at 100% screen rulings cover the following ranges:
less than 35 μm for cyan,
less than 29 μm for yellow,
greater than 18 μm for magenta, and
less than 37 μm for black.

Even more suitably, the channel widths at 30% screen rulings may be approximately:
45 μm for cyan,
57 μm for yellow,
57 μm for magenta, and
37 μm for black.

In an embodiment, the method may also include applying a speciality colour to the polymeric film. The speciality colour may be a colour such as a metallic coloured ink, a fluorescent coloured ink or a varnish ink. The speciality colour may be applied by a gravure roller in a line with the other gravure rollers.

Throughout this specification, characteristics of half tone dots such as screen angles, screen rulings, dot widths and channel widths are recited according to various embodiments of the present invention. Similarly, characteristics of cells formed in the surface of gravure rollers such as screen angles, screen rulings, cell widths and channel widths are also recited according to various embodiments of the present invention. It will be appreciated by those skilled in the art of the present invention that the quantitative values of the characteristics of the half tone dots are the same for the corresponding characteristics of the cells of the gravure rollers, and vice versa.

The present invention also relates to a set of rollers for a gravure printing press, each roller has cells for applying a particular standardised process colour in half tone dots to a polymeric film, and wherein a range of screen angles and a range of screen rulings are selected for the cells of each roller and are based on the ranges from the following Table,

| standardised | Screen angle | Screen ruling |
|---|---|---|
| process colour | (degrees) | (lines per cm) |
| cyan | from 55 to 65 | from 65 to 75 |
| Yellow | from 42 to 52 | from 52 to 62 |
| Magenta | from 32 to 42 | from 65 to 70 |
| Black | from 35 to 45 | from 90 to 110 |

whereby when in use, the cells of the rollers apply half tone dots of the standardised process colours to the polymeric film and at least a portion of the half tone dots are combined to form non-standardised process colours.

The above mentioned screen rulings and screen angles ranges have the benefit of minimising mis-registration of half tone dots and allow a large range of non-standardised process colours to be formed.

Although the set of rollers may comprising any number of rollers that is equal to or greater than 2 rollers, suitably the set of rollers includes from 2 to 6 rollers, and even more suitably 4 rollers in which the cells of the rollers have screen angles and screen rulings in the range defined above.

In a particular embodiment, the screen angles of the cells are approximately 59 degrees for cyan, 47 degrees for yellow, 37 degrees for magenta, and 40 degrees for black.

In a particular embodiment, the screen rulings are approximately 70 lines per cm for cyan, 57 lines per cm for yellow, 70 lines per cm degrees for magenta, and 99 lines per cm for black.

In the situation in which the standardised process colours include any one of cyan, yellow, magenta and black, and the screen rulings are applied at 100% to the polymeric film, the cell widths formed may cover the following ranges:
less than 184 μm for cyan,
greater than 156 μm for yellow,
greater than 123 μm for magenta, and
less than 186 μm for black.

Even more suitably, the cell widths at 100% screen rulings may be approximately:
143 μm for cyan,
181 μm for yellow,
176 μm for magenta, and
118 μm for black.

In an embodiment, the channel widths between the cells at 100% screen rulings cover the ranges:
less than 35 μm for cyan,
less than 29 μm for yellow,
greater than 18 μm for magenta, and
less than 37 μm for black.

Even more suitably, the channel widths between the cells at 30% screen rulings may be approximately:
45 μm for cyan,
57 μm for yellow,
57 μm for magenta, and
37 μm for black.

In an embodiment, the ink/colour densities measured by a densitometer and cover the following ranges:
greater than 1.3 for cyan,
greater than 1.35 for magenta,
greater than 1.05 for yellow, and
greater than 1.50 for black.

The present invention also relates to a method of manufacturing a set of rollers for a gravure printing press, the set of rollers comprising at least 2 rollers and the method including forming cells on each roller for applying half tone dots of a particular standardised process colour onto a polymeric film, and wherein a range of screen angles and a range of screen rulings are selected for the cells and are based on the ranges from the following Table:

| Standardised | Screen angle | Screen ruling |
|---|---|---|
| process colour | (degrees) | (lines per cm) |
| cyan | from 55 to 65 | from 65 to 75 |
| yellow | from 42 to 52 | from 52 to 62 |
| magenta | from 32 to 42 | from 65 to 70 |
| black | from 35 to 45 | from 90 to 110 |

In an embodiment, forming the cells includes engraving the cells on the rollers.

In another embodiment, forming the cells include etching the cells on the rollers.

Suitably, when the rollers are in use, the cells of the rollers apply half tone dots of the standardised process colours to the polymeric film and at least a portion of the half tone dots are combined to form non-standardised process colours.

Suitably, the method for making the gravure rollers may also include any one of the features of the gravure rollers mentioned above including: ranges of cell widths and ranged of channel widths.

### BRIEF DESCRIPTION OF THE DRAWINGS

The present invention will now be described further with reference to the accompanying drawings, of which:

FIGS. 1 and 2 are photographs of cells engraved on a gravure roller at 100% screen ruling for a cyan standardised process colour and on which the cell width and channel width have been marked respectively;

FIG. 3 is a photograph of cells engraved on a gravure roller at 30% screen ruling for cyan on which the cell width has been marked;

FIGS. 4 and 5 are photographs of cells engraved on a gravure roller at 100% screen ruling for black and on which the cell width and channel width have been marked respectively;

FIG. 6 is a photograph of cells engraved on a gravure roller at 30% screen ruling for black and on which the cell width has been marked;

FIGS. 7 and 8 are photographs of cells engraved on a gravure roller at 100% screen ruling for magenta and on which the cell width and channel width have been marked respectively;

FIG. 9 is a photograph of cells engraved on a gravure roller at 30% screen rulings for magenta and on which the cell width has been marked;

FIGS. 10 and 11 are photographs of cells engraved on a gravure roller at 100% screen ruling of yellow and on which the cell width and channel width have been marked respectively;

FIG. 12 is a photograph of cells engraved on a gravure roller at 30% screen rulings for yellow and on which the cell width has been marked; and

FIG. 13 is a block diagram of a sequence of steps for the overall printing process including the preferred embodiment.

### EXAMPLE

A preferred embodiment of the present invention will now be described with reference to an example. The example involved printing onto a polymeric substrate using a gravure printing press having 4 rollers. The polymeric substrate was in the form of a white oriented polypropylene film that is commercially available under the trade name MH247 from Mobil (ExxonMobil). The inks applied by the polypropylene film were a solvent based ink and suitable inks include the following inks commercially available under the trade names MR-189 by Sigwerk and EXT2 DIC by Helio.

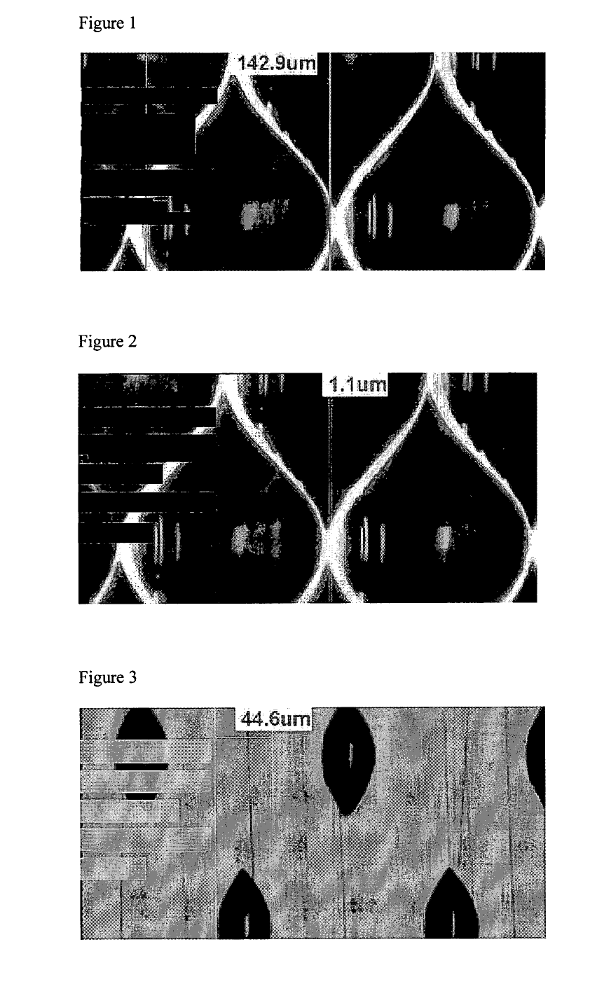

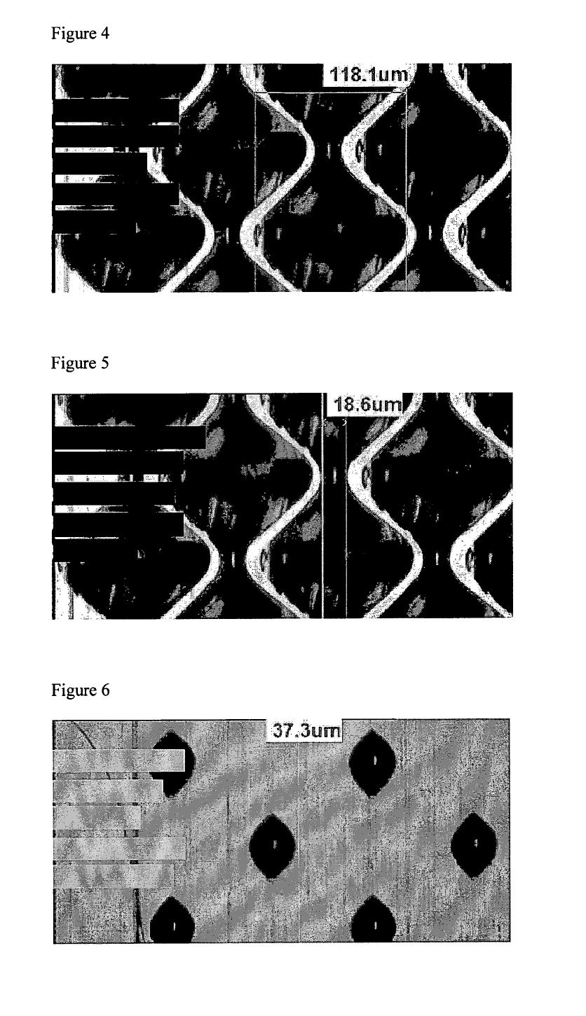

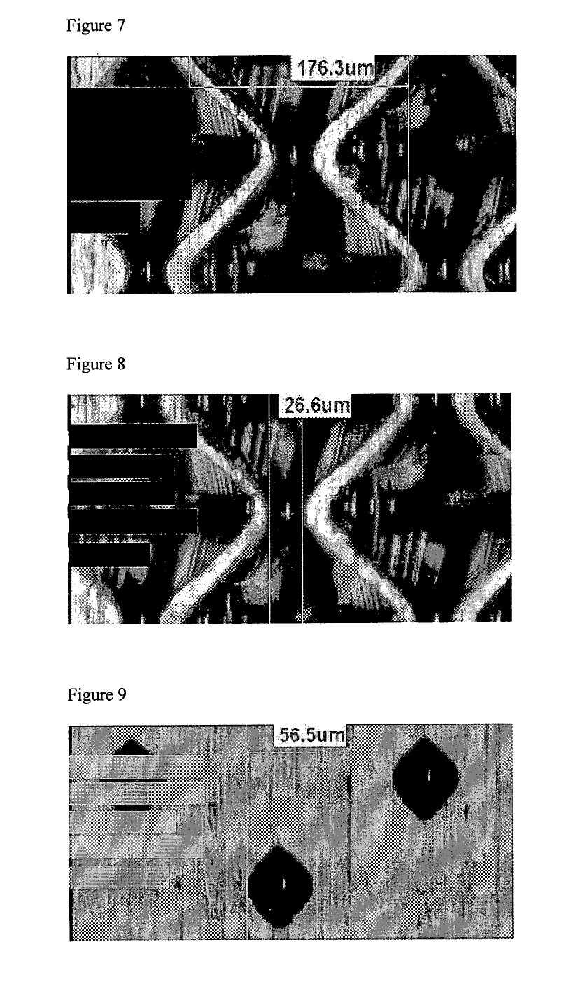

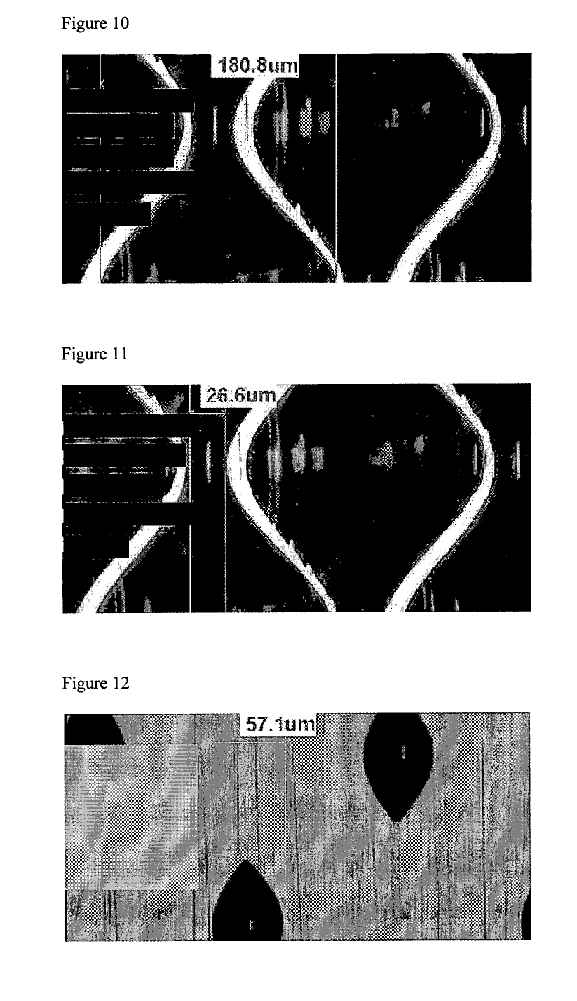

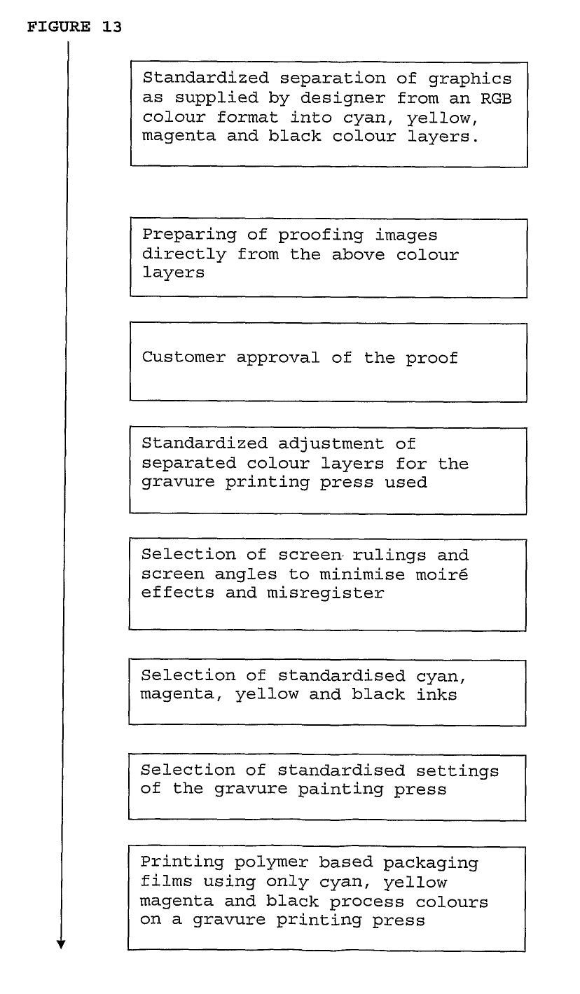

The inks were applied to the polypropylene film using the gravure rollers shown in FIGS. 1 to 12. The surface of the gravure rollers was engraved to form cells having desired screen angles and screen rulings suitable for print standardised colours, namely cyan, yellow, magenta and black (CYMK) and combining the standardised colours to create non-standardised colours while minimising mis-registration effects.

A series of new screen angles was chosen based on the realisation that magenta, in particular, was unstable across the full width of the gravure roll. Table 1 below includes a summary of the screen angles of a prior art gravure roller and half tone dots in which CYMK and red were applied, and a non-standardised colour, namely brown was applied to the film. Table 1 also includes the screen angles according to the example in which CYMK standard colours only were applied to the polypropylene film at selected screen angles to facilitate the standard colours being combined to create non-standardised colours as desired. The screen angles of the cells of the gravure cells are diagrammatically depicted in FIGS. 1 to 12 which, in turn, represents the screen angles of half tone dots of the CYMK colours applied to the polypropylene film.

TABLE 1
Summary of cell angles and screen rulings
of the prior art and the example.

| | |
|---|---|
| Prior Art | Example |

| | | Nominal | | Nominal |
|---|---|---|---|---|
| | Cell | screen | Cell | screen |
| | angle, | ruling, | angle, | ruling, |
| Colour | degrees | line/cm | degrees | lines/cm |
| Cyan | 30 | 70 | 59 | 70 |
| Yellow | 45 | 70 | 47 | 57 |
| Magenta | 60 | 70 | 37 | 70 |
| Black | 30 | 70 | 40 | 99 |
| Red | 30 | 70 | n/a | n/a |
| Brown | 30 | | n/a | n/a |

Table 1 shows:
A flattening of the shape of the cell (lower cell angles) for the magenta cells. The effect of flattening the cells will be to produce a shorter but wider half tone dot.
A sharpening of the shape of the cell (higher cell angle) for the cyan cells. The effect of flattening the cells will be to produce a taller but narrower half tone dot.

A series of new screen rulings have been chosen to affect the amount of ink transferred between the gravure roller and the film.

Table 2 below includes a summary of the cell widths and channel widths at 100% screen ruling for standardised colours CYMK and red, and a non-standardised colour, namely brown according to a prior art roller. Table 2 also includes the cell widths and channel widths at 100% screen ruling for CYMK standard colours only as applied according to the example of the polypropylene film and in which the cell width and channel width have been selected to enable the standardised colours to be combined to form non-standardised colours as desired. The cell width and channel width of the gravure roller for cyan, black, magenta and yellow are shown in FIGS. 1, 2, 4, 5, 7, 8, 10 and 11 respectively. Half tone dots applied by the gravure rollers have dot widths substantially the same as the cell widths and are separated by corresponding channels widths.

TABLE 2
Cell dimensions for 100% screen cells,
for the prior art and for the example.

| | |
|---|---|
| Prior art | Example |

| | Cell | Channel | Cell | Channel |
|---|---|---|---|---|
| Colour | width, um | width, um | width, um | width, um |
| cyan | 184 | 35 | 143 | 1 |
| Yellow | 156 | 29 | 181 | 27 |
| magenta | 123 | 18 | 176 | 27 |
| black | | | 118 | 19 |
| brown | 186 | 35 | n/a | n/a |
| red | 189 | 35 | n/a | n/a |

Table 2 shows that for the 100% screen cells:
an increase in the size of the yellow and magenta cell;
a decrease in the size of the cyan and black cells.
hence there will be relatively more yellow and magenta ink applied.

Table 3 below is a summary of the cell widths of the prior art and cells widths of the example at a 30% screen ruling. The cell widths of the gravure roller are diagrammatically depicted in FIGS. 3, 6, 9 and 12. Half tone dots applied by the gravure rollers also have substantially similar widths.

TABLE 3
width of the dimensions for 30% screening cells for the
existing process and in one embodiment of this invention.

| | Width of 30% cell, | Width of 30% cell, |
|---|---|---|
| Colour | prior art, um | example |
| Cyan | 60 | 45 |
| Yellow | 50 | 57 |
| Magenta | 39 | 57 |
| Black | | 37 |
| Brown | 60 | n/a |
| Red | 61 | n/a |

Table 3 shows that for the 30% cells:
An increase in the size of the yellow and magenta cells
A decrease in the size of the cyan and black cells.

The amount of ink applied to the polymeric substrate, also known as “film weight” (or ink film weight) can be expressed in terms of grams of ink applied per square metre of polymeric film (g/m²). Table 4 below provides a breakdown of the film weights at 100% screen ruling for CYMK standardised colours of the prior art process and according to the example.

TABLE 4
film weights of a prior art reference
sample and of the example g/m²

| Standardised | Film weight (g/m²) | Film weight (g/m²) |
|---|---|---|
| colour | of the prior art | of the example |
| Cyan | 0.8 | 0.8 |
| Magenta | 1.2 | 0.9 |
| Yellow | 1.4 | 0.8 |
| Black | 0.5 | 0.9 |

As can be seen from Table 4, one of outcomes of shifting the screen angles and screen rulings in accordance with the example is that film weights for the different standardised colours becomes more evenly distributed compared to the prior art film weights.

Colour/ink densities of the example were also measured using a densitometer. A densitometer works by measuring the amount of light reflected by a printed substrate. The higher the density of a solid colour area, i.e. the less light reflected, the thicker the colour/ink applied; and conversely the lower the density, i.e. the more light refected, the thinner the colour/ink applied. The densities of the prior art substrates and of the example are as follows:

| | Density ranges of | |
|---|---|---|
| | prior art printed | Density ranges of |
| Standard colour | colours | the example |
| cyan | 1.20 to 1.30 | 1.35 |
| magenta | 1.25 to 1.35 | 1.41 |
| Yellow | 0.90 to 1.05 | 1.08 |
| Black | 1.40 to 1.50 | 1.70 |

### ADVANTAGES

One of the benefits of the preferred embodiment of the present invention is that the image to be printed can be separated into four process colour layers using a standardized colour separation process that does not routinely change from print job to print job. Moreover, the principal advantages in repeatedly using standardised process colours without non-standardised process colours allows for:
a) much faster prepress and press set up processes compared to the current art where the press is manually adjusted for every print job;
b) deskilling of these staff required for the prepress and printing activities, reducing the cost of employing these staff;
c) standard processes can transferred to different prepress operations with little local customization required;
d) an improved ability to achieve acceptable print quality using three to six standardized process colours, instead of a greater number of process colours, or the combination of the use of process colours and spot colours.
e) reducing the extent to which settings of the printing press must be adjusted by avoiding spot colours.

Another benefit of the preferred embodiment of the present invention is that the image printed is able to be corrected prior to the production of printing rollers using gamma curves that are standardized for the printing press. Moreover, the gamma curves applied to achieve the correction do not routinely change from print job to print job.

Yet another benefit is that the print job can be proofed by the designer, brand owner or other approving party using standard proofing processes such as inkjet printing or the Kodak Donar processes. Moreover, the proof is able to be printed directly from the colour layers produced by the standardised colour separation process.

In the claims in relation to this invention and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that the prior art forms a part of the common general knowledge in the art, in Australia or any other country.

1. A method of printing an image on a polymeric film using a gravure printing press having a plurality of gravure rollers, the method comprising:
sequentially applying at least 2 standardised process colours to the polymeric film in half tone dots by respective gravure rollers, wherein at least a portion of the half tone dots of two or more standard process colours combine to form non-standardised process colour(s), and a range of screen angles and a range of screen rulings are selected for the half tone dots of each standardised process colour to minimise mis-registration of the half tone dots that combine to form the non-standardised process colour, and wherein all of the non-standardised process colours of the image are formed by combining 2 or more of the standardised process colours and the standardised process colours are each in the form of a solvent based ink.

2. The method of claim 1, wherein method includes applying 4 standardised process colours.

3. The method of claim 1, wherein the standardised process colours include cyan, magenta, yellow, and black.

4. The method of claim 3, wherein the screen angles of the half tone dots comprise:
from 55 to 65 degrees for cyan,
from 42 to 52 degrees for yellow,
from 32 to 42 degrees to magenta, and
from 35 to 45 degrees for black.

5. The method of claim 3, wherein the screen angles comprise approximately:
59 degrees for cyan,
47 degrees for yellow,
37 degrees for magenta, and
40 degrees for black.

6. The method of claim 3, wherein the screen rulings of the half tone dots comprise:
from 65 to 75 lines per cm for cyan,
from 52 to 62 lines per cm for yellow,
from 65 to 70 lines per cm for magenta, and
from 90 to 110 lines per cm for black.

7. The method of claim 3, wherein the screen rulings comprise approximately: 70 lines per cm for cyan, 57 lines per cm for yellow, 70 lines per cm degrees for magenta, and 99 lines per cm for black.

8. The method of claim 3, wherein when the screen rulings are applied at 100%, the colour to film weights of the standardised process colours comprise the following ranges:
less that 1.4 g/m² for yellow,
less than 1.0 g/m² for magenta,
approximately 0.8 g/m² for cyan, and
more than 0.5 g/m² for black.

9. The method of claim 3, wherein when the screen ruling are applied at 100%, the colour to film weights of the standardised process colours comprise approximately:
0.8 g/m2 for yellow,
0.9 g/m2 for magenta,
0.8 g/m2 for cyan, and
0.9 g/m2 for black.

10. The method of claim 3, wherein when the screen rulings are applied at 100%, the width of the half tone dots comprises the following ranges:
less than 184 μm for cyan,
greater than 156 μm for yellow,
greater than 123 μm for magenta, and
less than 186 μm for black.

11. The method of claim 3, in wherein when the screen rulings are at 100%, the width of the half tone dots comprises approximately:
143 μm for cyan,
181 μm for yellow,
176 μm for magenta, and
118 μm for black.

12. The method of claim 3, wherein when screen rulings are at 100%, the channel widths between the half tone dots comprise the following ranges:
less than 35 μm for cyan,
less than 29 μm for yellow,
greater than 18 μm for magenta, and
less than 37 μm for black.

13. The method of claim 3, wherein when the screen rulings are at 30%, the channel widths between the half tone dots comprise approximately:
45 μm for cyan,
57 μm for yellow,
57 μm for magenta,
and 37 μm for black.

14. The method of claim 1, wherein colour densities of the standardised colours measured by a densitometer comprise:
greater than 1.3 for cyan,
greater than 1.35 for magenta,
greater than 1.05 for yellow, and
greater than 1.50 for black.

15. The method of claim 1, wherein the non-standardised process colours form part of solid tone areas of the image.

16. The method of claim 1, wherein the non-standardised process colours comprises secondary and tertiary colours.

17. The method of claim 1, wherein the method further comprises applying a speciality colour to the polymeric film by a gravure roller.

18. A set of rollers for a gravure printing press, each roller having cells for applying a particular standardised process colour in half tone dots to a polymeric film, and wherein a range of screen angles and a range of screen rulings are selected for the cells of each roller and are based on the ranges from the following Table,

| Standardised | Screen angle | Screen ruling |
|---|---|---|
| process colour | (degrees) | (lines per cm) |
| Cyan | from 55 to 65 | from 65 to 75 |
| Yellow | from 42 to 52 | from 52 to 62 |
| Magenta | from 32 to 42 | from 65 to 70 |
| Black | from 35 to 45 | from 90 to 110 |

whereby when in use, the cells of the rollers apply half tone dots of the standardised process colours to the polymeric film, and at least a portion of the half tone dots are combined to form non-standardised process colours.

19. The set of rollers of claim 18, comprising 4 rollers, wherein the screen angle and the screen ruling of the cells of each roller are based on the ranges for cyan, magenta, yellow and black respectively in the Table.

20. The set of rollers of claim 19, wherein the screen angles of the cells for the 4 rollers comprise approximately 59 degrees for cyan, 47 degrees for yellow, 37 degrees for magenta, and 40 degrees for black.

21. The set of rollers of claim 19, wherein the screen rulings comprise approximately 70 lines per cm for cyan, 57 lines per cm for yellow, 70 lines per cm degrees for magenta, and 99 lines per cm for black.

22. The set of rollers of claim 19, in wherein when the screen rulings are applied at 100%, the cell widths formed comprise the following ranges:
less than 184 μm for cyan,
greater than 156 μm for yellow,
greater than 123 μm for magenta, and
less than 186 μm for black.

23. The set of rollers of claim 19, in wherein when screen rulings are at 100%, the channel widths between the cells comprise the ranges:
less than 35 μm for cyan,
less than 29 μm for yellow,
greater than 18 μm for magenta, and
less than 37 μm for black.

24. A method of manufacturing a set of rollers for a gravure printing press, the set of rollers comprising at least 2 rollers and the method comprising forming cells on each roller for applying half tone dots of a particular standardised process colour onto a polymeric film, and wherein a range of screen angles and a range of screen rulings are selected for the cells and are based on the ranges from the following Table:

| Standardised | Screen angle | Screen ruling |
|---|---|---|
| process colour | (degrees) | (lines per cm) |
| cyan | from 55 to 65 | from 65 to 75 |
| Yellow | from 42 to 52 | from 52 to 62 |
| Magenta | from 32 to 42 | from 65 to 70 |
| Black | from 35 to 45 | from 90 to 110 |

25. The method of claim 24, wherein forming the cells comprises engraving the cells on the rollers.
